(19) United States
(12) Patent Application Publication
(10) Pub. No.: US 2025/0315714 A1
(43) Pub. Date: Oct. 9, 2025

(54) SYSTEMS, METHODS, AND COMPUTER PROGRAM PRODUCTS FOR MACHINE LEARNING FOR DATACENTER APPLICATIONS

(71) Applicant: MELLANOX TECHNOLOGIES, LTD., Yokneam (IL)

(72) Inventors: Gal DALAL, Shimshit (IL); Benjamin FUHRER, Tel Aviv (IL); Chen TESSLER, Zichron Yaakov (IL); Yuval SHPIGELMAN, Netanya (IL); Gal YEFET, Haifa (IL); Doron HAIM, Herzliya (IL)

(73) Assignee: MELLANOX TECHNOLOGIES, LTD., Yokneam (IL)

(21) Appl. No.: 18/625,851

(22) Filed: Apr. 3, 2024

(51) Int. Cl. G06N 20/00

(52) U.S. Cl. CPC G06N 20/00

(57) ABSTRACT

Methods, systems, devices, and computer program products for machine learning in datacenter applications are provided. An example method includes receiving, by a centralized computing device, data packets from a networked device communicably coupled with the centralized computing device. The networked device is associated with performance of at least a first machine learning based task, and each of the data packets include data entries generated by the networked device based on data traffic associated with the at least one networked device and/or one or more modifications thereto. The method further includes generating updated operational parameters associated with the first machine learning based task based on the data entries forming the plurality of data packets where the updated operational parameters are generated locally by the centralized computing device. The method also includes transmitting, by the centralized computing device, the updated operational parameters to the networked device.

### TECHNOLOGICAL FIELD

Embodiments of the present disclosure relate generally to networking and computing systems, and, more particularly, to machine learning methods and systems that occur locally in datacenter clusters.

### BACKGROUND

Datacenters, high performance computing clusters, and/or the like are often implemented via distributed network components or devices (e.g., hosts, servers, racks, switches, nodes, etc.). For example, a datacenter or computing cluster may be formed of a plurality of networked devices that are communicably coupled with a centralized computing device and/or to one another. Each of these networked devices may generate data packets based on data traffic associated with the operations, machine learning based or otherwise, performed by the respective networked device. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure therefore provide for methods, systems, apparatuses, and computer program products for machine learning that occurs locally at the datacenter cluster level. With reference to an example computer-implemented method for machine learning, the method may include receiving, by a centralized computing device, one or more data packets from at least one networked device communicably coupled with the centralized computing device. The at least one networked device may be associated with performance of at least a first machine learning based task, and each of the one or more data packets may include one or more data entries generated by the at least one networked device based on data traffic associated with the at least one networked device and/or one or more modifications to the data entries by the networked device. The computer-implemented method may further include generating one or more updated operational parameters associated with the first machine learning based task based on the one or more data entries forming the plurality of data packets. The one or more updated operational parameters may be generated locally by the centralized computing device. The method may further include transmitting, by the centralized computing device, the one or more updated operational parameters to the at least one networked device.

In some embodiments, the computer-implemented method may further include accessing at least a first machine learning model implicating performance of the first machine learning based task. In such an embodiment, the method may further include training the first machine learning model based on the one or more data entries forming the plurality of data packets and generating the one or more updated operational parameters based on an outcome of the first machine learning model.

In some further embodiments, the computer-implemented method may further include iteratively training the first machine learning model based on iterative receipt of data packets from the at least one networked device.

In some further embodiments, the first machine learning model may be associated with a neural network. In such an embodiment, the computer-implemented method may further include training the neural network based on the one or more data entries forming the plurality of data packets and generating one or more neural network weights as the one or more updated operational parameters.

In any embodiment, the centralized computing device may include a data processing unit (DPU) or a graphics processing unit (GPU) configured to generate the one or more updated operational parameters associated with the first machine learning based task.

In any embodiment, the centralized computing device may be communicably coupled with a plurality of networked devices including the at least one networked device. In such an embodiment, each of the plurality of networked devices may be associated with performance of at least the first machine learning based task.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example datacenter cluster in accordance with an example embodiment of the present disclosure;

FIG. 2 illustrates a block diagram of example circuitry of an example networked device that may be specifically configured in accordance with an example embodiment of the present disclosure;

FIG. 3 illustrates an example data buffer within which an example networked device aggregates data entries associated with data traffic in accordance with an example embodiment of the present disclosure;

FIG. 4 illustrates a block diagram of example circuitry of a centralized computing device that may be specifically configured in accordance with an example embodiment of the present disclosure;

FIG. 5 illustrates an example centralized data buffer within which an example centralized computing device aggregates data packets received from the networked device(s) in accordance with an example embodiment of the present disclosure;

FIG. 6 illustrates an example data processing unit (DPU) configuration that may operate as an example networked device and/or an example centralized computing device in accordance with one or more example embodiments of the present disclosure;

FIG. 7 illustrates a flowchart of an example method for generating, locally within a datacenter cluster, updated operational parameters for machine learning based tasks in accordance with some embodiments of the present disclosure; and

FIG. 8 illustrates a flowchart of an example method for training machine learning models locally within a datacenter cluster in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, datacenters, high performance computing clusters, and/or the like are often implemented via distributed network components or devices (e.g., hosts, servers, racks, switches, nodes, etc.). For example, a datacenter or computing cluster may be formed of a plurality of networked devices that are communicably coupled with a centralized computing device and/or to one another. In datacenters and other networking applications, each datacenter cluster may also be associated with a set of algorithms that perform various tasks (e.g., congestion control, adaptive routing, configuration tuning, error correction, power management, etc.). Each datacenter cluster, and the networked devices forming these clusters, however, exhibits unique behavior such that an algorithm that is optimal for one datacenter cluster may be suboptimal for another datacenter cluster associated with the same or similar machine learning based task. Conventional solutions for optimizing algorithmic solutions (e.g., machine learning based tasks) are typically optimized offline, such as in an inhouse simulation or controlled datacenter, and then provided to a production datacenter (e.g., a live environment of a plurality of clusters). In doing so, these conventional solutions fail to provide tailored algorithms that may adapt to the dynamically changing conditions of production datacenter environments formed of clusters of networked devices each of which have unique behavior. In other words, the offline algorithmic training used by conventional systems not only provides suboptimal operational parameters for some networked devices, but these solutions are also inherently slow to respond to rapidly changing datacenter conditions due to their offline nature.

In order to address these problems and others, the embodiments of the present disclosure provide methods for machine learning that perform optimization operations local to the datacenter cluster (e.g., without the need for offline operations). For example, a centralized computing device (e.g., a learner device) may receive data packets that are generated by various networked devices (e.g., worker devices) in the datacenter cluster where each networked device may be associated with performance of at least a first machine learning based task, algorithm, etc. The centralized computing device may perform one or more optimization processes in response to the received data packets, such as optimization of weights, gradients, etc. used by a neural network, and provide these updated weights (e.g., updated operational parameters) to the networked devices. This optimization may occur iteratively at the datacenter cluster level to iteratively provide optimized operational parameters to the networked devices that are cluster/task specific. The operational parameter generation occurs locally by the centralized computing device within a datacenter cluster so as to reduce or otherwise avoid any computational burden on other systems or components (e.g., at the host level or otherwise).

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Example Datacenter Cluster

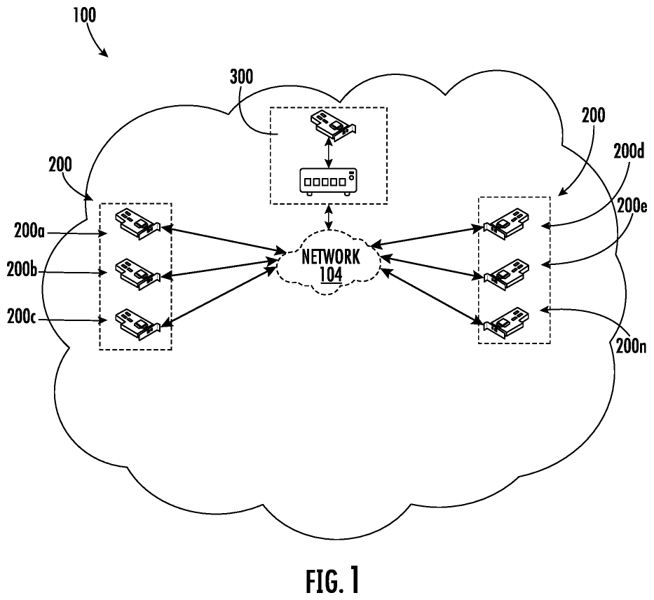

FIG. 1 illustrates an example datacenter cluster 100 with networked devices (e.g., a networked system, fabric, etc.). It will be appreciated that the system 100 is provided as an example of an embodiment(s) and should not be construed to narrow the scope or spirit of the disclosure. The depicted datacenter cluster 100 of FIG. 1 may include a centralized computing device 300 communicably coupled with one or more networked devices 200 (e.g., networked devices 200 a-n) via a network 104. The centralized computing device 300 may be configured to control or otherwise influence operations of the datacenter cluster 100 by, for example, generating operational parameters that at least partially impact the operations of the networked devices 200a-n forming the datacenter cluster 100. As described hereinafter, the centralized computing device 300 may operate as a learning device in that the centralized computing device 300 may receive data packets from respective networked devices 200a-n that include data entries generated based on data traffic associated with the respective networked device 200 (e.g., or modifications thereto) performing associated machine learning (ML) based tasks (e.g., operations at least partially controlled or impacted by ML techniques). The centralized computing device 300 may, thereafter, generate updated operational parameters based on the data packets, and distributed these operational parameters to the networked devices 200a-n. These operations, for example, may occur entirely within the datacenter cluster 100 or otherwise without the use of host-level computing resources (e.g., without burdening computing resources at different network levels, of different datacenter clusters, etc.).

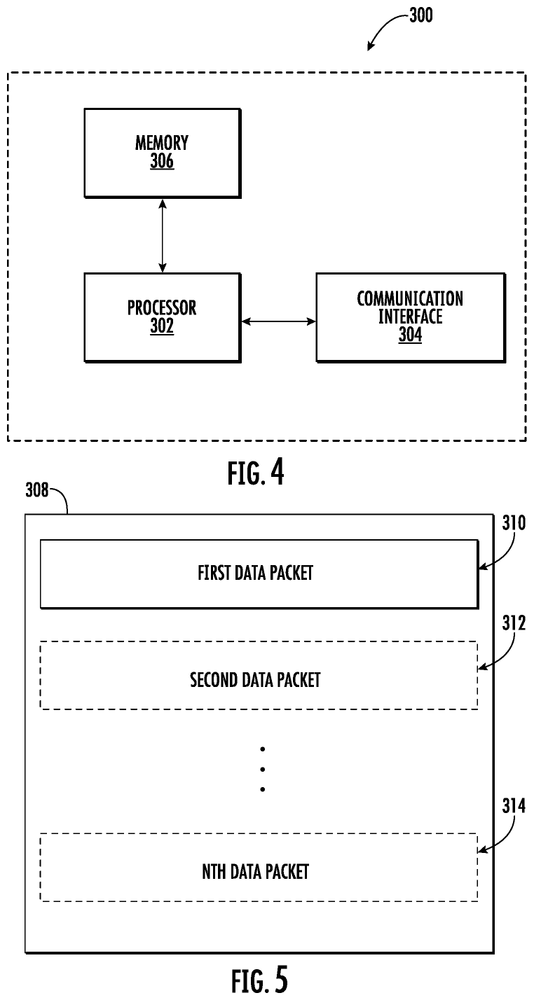

Although described hereinafter with reference to a centralized computing device 300, the present disclosure contemplates that the operations described hereafter with reference to the centralized computing device 300 (e.g., datacenter cluster level operations) may be performed by any computing device, system orchestrator, central processing unit (CPU), graphics processing unit (GPU), data processing unit (DPU) and/or the like, alone or in any combination. Furthermore, although illustrated as a single device (e.g., centralized computing device 300), the present disclosure contemplates that any number of distributed components may collectively be used to form the centralized computing device 300 and/or to perform the operations associated with the centralized computing device 300. As described above and hereinafter, the centralized computing device 300 may operate to manage the datacenter cluster 100. The centralized computing device 300 may take many forms or configurations but will include circuitry components configured to perform the operations described herein with reference to the centralized computing device 300, such as the example circuitry components illustrated in FIG. 4.

The datacenter cluster 100 may, as illustrated in FIG. 1, further include one or more networked devices 200a-n that are connected with the centralized computing device 300 via the network 104. As described herein, each of the networked device 200a-n may operate as worker device in that the networked devices 200a-n may be associated with the performance of various machine learning based tasks (e.g., congestion control, cluster wide zero thermal throttling (ZTT), node synchronization, error correction, power management, motherboard configuration, etc.). In operation, the networked devices 200a-n may generate data packets that include data entries indicative of or otherwise associated with the data traffic of the respective network device 200a-n. By way of a non-limiting example, the plurality of networked devices 200a-n may include a first networked device 200a that is configured to perform various machine learning based tasks. The first networked device 200a may be configured to collect data traffic that is observed by the first networked device 200a (e.g., generate data entries associated with the data traffic) as well as generate data entries indicative of the decisions (e.g., inferences or the like) performed by the first networked device 200a based on the data traffic and the outcomes of these decisions (e.g., modifications to the data traffic or the like).

Similarly, the plurality of networked devices 200a-n may include a second networked device 200b that is also configured to perform various machine learning based tasks. In some embodiments, the second networked device 200b may be associated with performance of the same machine learning based task while in other embodiments, the second networked device 200b may be associated with a different machine learning based task. The second networked device 200b may similarly be configured to collect data traffic that is observed by the second networked device 200b (e.g., generate data entries associated with the data traffic) as well as generate data entries indicative of the decisions (e.g., inferences or the like) performed by the second networked device 200b based on the data traffic and the outcomes of these decisions (e.g., modifications to the data traffic or the like). Although described herein with reference to example first and second networked devices 200a, 200b, the present disclosure contemplates that the datacenter cluster 100 may include any number of networked devices 200a-n in any configuration based on the intended application of the datacenter cluster 100.

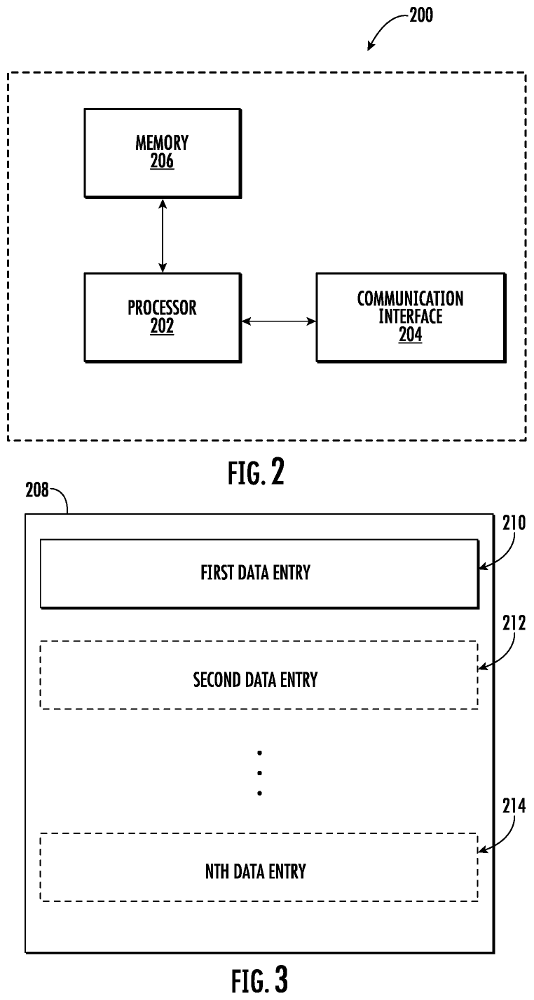

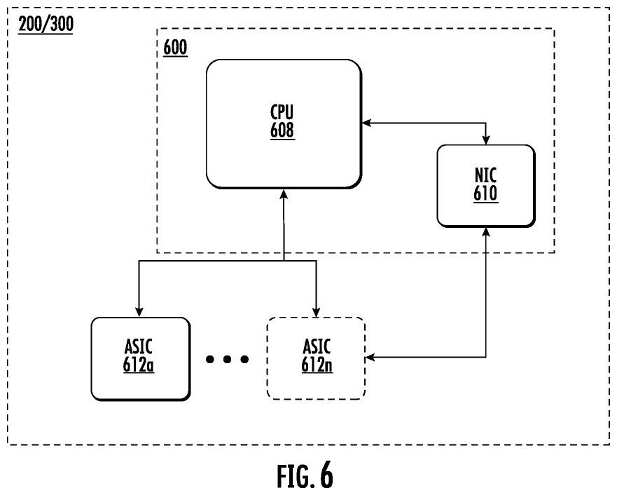

Although described hereinafter with reference to networked devices 200a-n, the present disclosure contemplates that the operations described hereafter with reference to various networked devices 200a-n (e.g., data packet generation, decision/inference performance, etc.) may be performed by any computing device, system orchestrator, central processing unit (CPU), graphics processing unit (GPU), data processing unit (DPU) and/or the like, alone or in any combination. The networked devices 200a-n may take many forms or configurations but will include circuitry components configured to perform the operations described herein with reference to the networked devices 200a-n, such as the example circuitry components illustrated in FIG. 2. In some embodiments, each of the networked devices 200a-n may include the same or substantially the same circuitry components, such as in instances in which each of the networked devices 200a-n comprises a DPU (e.g., DPU 600 in FIG. 6). The present disclosure, however, contemplates that each of the networked devices 200a-n may include differing circuitry components, configurations, and/or the like based on the intended application of the respective networked device 200a-n. In some embodiments, each of the networked devices 200a-n may be configured to perform the same or substantially the same operations (e.g., in number, type, etc.). In other embodiments, one or more of the networked devices 200a-n may be configured to perform different operations (e.g., in number, type, etc.).

To facilitate or otherwise enable this connectivity in the datacenter cluster 100, the communication network 104 may be any means including hardware, software, devices, or circuitry that is configured to support the transmission of traffic (e.g., data, packets, signals, etc.) between the devices forming the datacenter cluster 100. For example, the communication network 104 may be formed of components supporting wired transmission protocols, such as, digital subscriber line (DSL), InfiniBand®, Ethernet, fiber distributed data interface (FDDI), or any other wired transmission protocol obvious to a person of ordinary skill in the art. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI eXtended (PCI-X), Accelerated Graphics Port (AGP), or other similar high-speed communication connection. Further, the communication network 104 may be comprised of any combination of the above mentioned protocols. In some embodiments, such as when networked devices 200a-n and the centralized computing device 300 are formed as part of the same physical device, the communication network 104 may include the on-board wiring providing the physical connection between the component devices. In some embodiments, the communication network 104 may enable remote direct memory access (RDMA) based communication. For example, the networked devices 200a-n may be configured to, in transmitting data packets, directly access the memory of the centralized computing device 300 without involving the operating system of the centralized computing device 300, and vice versa.

### Example Networked Device Circuitry

With reference to FIG. 2, example circuitry components of an example networked device 200 are illustrated that may, alone or in combination with any of the components described herein, be configured to perform the operations regarding data packet generation. As shown, a networked device 200 may include, be associated with, or be in communication with processor 202, a memory 206, and a communication interface 204. The processor 202 may be in communication with the memory 206 via a bus for passing information among components of the networked device 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processor 202. Additionally or alternatively, the memory 206 could be configured to store instructions for execution by the processor 202. As shown in FIG. 3, the memory 206 may be configured to at least partially store a data buffer 208 within which the networked device 200 aggregates data entries associated with the networked device 200.

The networked devices 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a non-limiting example, the communication interface 204 may include a host interface (e.g., PCIe or the like) and a network interface (e.g., Ethernet, InfiniBand®, or the like).

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the networked device(s) 200 may provide or supplement the functionality of particular circuitry.

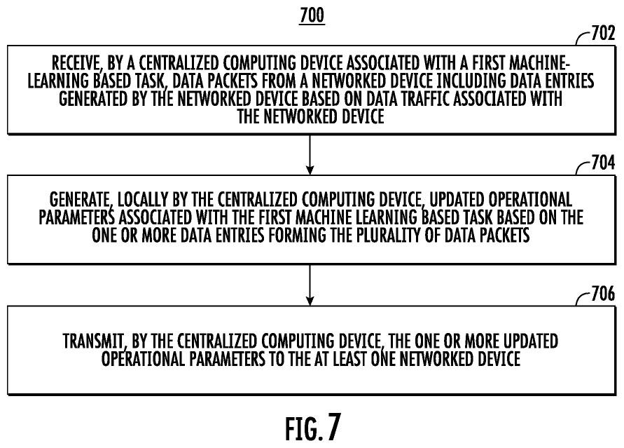

With reference to FIG. 3, an example first data buffer 208 within which an example the networked device 200 aggregates data entries associated with the data traffic of networked device 200 during performance of the associated machine learning based task or otherwise. As shown, the first data buffer 208 may be configured to store a first data entry 210, a second data entry 212, . . . , and Nth data entry 214. As described hereinafter with reference to the operations of FIG. 7, an example first networked device 200a may be configured to generate data entries associated with data traffic of the first networked device 200a. Each of the data entries 210, 212, 214 may include data indicative of any attribute, parameter, characteristic, etc. of the first networked device 200a as described herein. The present disclosure contemplates that the first data buffer 208 may include any number of data entries 210, 212, 214 based on the operations of the first networked device 200a. Although described herein with reference to an example first data buffer 208 for the first networked device 200a, the present disclosure contemplates that each of the networked devices 200a-n may include a respective buffer within which the respective networked device 200a-n aggregates its respective data entries. The present disclosure further contemplates that the example data buffers (e.g., the first data buffer 208) may be configured to store a one or more manipulated outputs generated based on manipulations to the data entries as described herein.

### Example Centralized Computing Device Circuitry

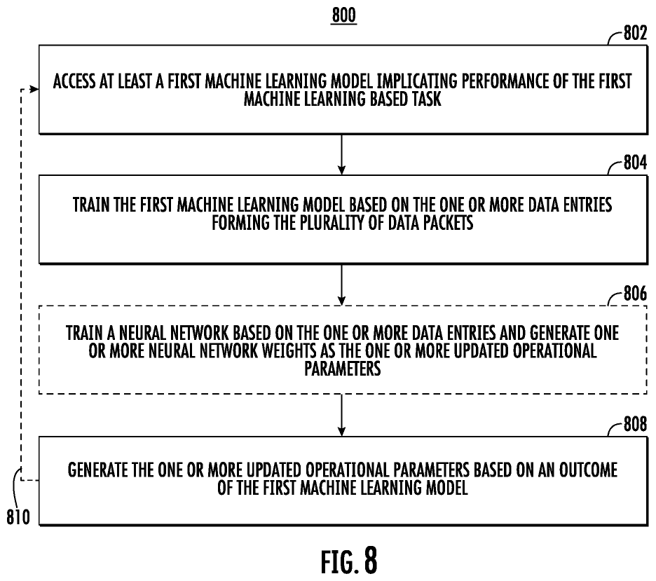

Similar to the networked devices 200, with reference to FIG. 4, example circuitry components of an example centralized computing device 300 are illustrated that may, alone or in combination with any of the components described herein, be configured to perform the operations described herein with reference to FIGS. 7-8. As shown, the centralized computing device 300 may include, be associated with or be in communication with processor 302, a memory 306, and a communication interface 304. The processor 302 may be in communication with the memory 306 via a bus for passing information among components of the centralized computing device 300. The memory 306 may be non-transitory and may include, for example, one or more volatile and/or non-volatile memories. In other words, for example, the memory 306 may be an electronic storage device (e.g., a computer readable storage medium) comprising gates configured to store data (e.g., bits) that may be retrievable by a machine (e.g., a computing device like the processing circuitry). The memory 306 may be configured to store information, data, content, applications, instructions, or the like for enabling the apparatus to carry out various functions in accordance with an example embodiment of the present disclosure. For example, the memory 306 could be configured to buffer input data for processing by the processor 302. Additionally or alternatively, the memory 306 could be configured to store instructions for execution by the processor 302. As shown in FIG. 5, the memory 306 may be configured to at least partially store a centralized data buffer 308 within which the centralized computing device 300 aggregates at least the one or more data packets received from the networked device(s) 200.

The centralized computing device 300 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 302 may be embodied in a number of different ways. For example, the processor 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 302 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 302 may be configured to execute instructions stored in the memory 306 or otherwise accessible to the processor 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 302 is embodied as an executor of instructions, the instructions may specifically configure the processor to perform the algorithms and/or operations described herein when the instructions are executed. However, in some cases, the processor 302 may be a processor of a specific device configured to employ an embodiment of the present disclosure by further configuration of the processing circuitry by instructions for performing the algorithms and/or operations described herein. The processor 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a non-limiting example, the communication interface 304 may include a host interface (e.g., PCIe or the like) and a network interface (e.g., Ethernet, InfiniBand®, or the like).

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the centralized computing device 300 may provide or supplement the functionality of particular circuitry.

With reference to FIG. 5, an example centralized data buffer 308 within which an example the centralized computing device 300 aggregates at least the one or more first data packets received from the networked device(s) 200. As shown, the centralized data buffer 308 may be configured to store a first data packet 310, a second data packet 312, . . . , and data packet 314. As described hereinafter with reference to the operations of FIGS. 7-8, an example centralized computing device 300 may be configured to receive data packets from the networked device(s) 200 that includes data entries associated with the data traffic of the networked device(s) 200 performing machine learning based tasks. Each of the data packets 310, 312, 314 may include data indicative of any attribute, parameter, characteristic, etc. of the respective networked device 200 associated with the data packet. As such, in some embodiments, each of the data packets 310, 312, 314 may include one or more data entries identifying the networked device 200a-n associated with the data packet 310, 312, 314. The present disclosure contemplates that the centralized data buffer 308 may include any number of data packet 310, 312, 314 based on the operations of the centralized computing device 300 and/or the networked device(s) 200.

As described above and hereinafter, the networked device(s) 200 may be referred to as worker devices, and the centralized computing device 300 may be referred to as a learning device. Although described with reference to FIGS. 2 and 4 as potentially different device types (e.g., devices that may differ in circuitry components, hardware, and/or the like), the present disclosure contemplates that, in some embodiments, each of the devices 200, 300 forming the datacenter cluster 100 may be the same or substantially the same in hardware and/or operation, function, etc. By way of example, any of the devices 200, 300 forming the datacenter cluster 100 may operate as the centralized computing device 300 or learning device (e.g., any of the networked devices 200 may perform the operations described herein with reference to the centralized computing device 300). In such an embodiment, for example, a Message Passing Interface (MPI) communication protocol or other software abstraction may operate to automatically and autonomously select one of the networked devices 200 to operate as the centralized computing device 300 (e.g., the learning device). This categorization or designation of a networked device 200 as the centralized computing device 300 (e.g., learning device) may occur without an explicit instruction by an entity associated with the datacenter cluster. Said differently, the present disclosure contemplates that any of the devices described herein may be configured to perform the operations associated with the centralized computing device 300 (e.g., learning device) based on the intended application of the datacenter cluster 100.

By way of an additional example, in some embodiments, every node (e.g., device 200, 300) of the datacenter cluster 100 may operate as both a worker device and a learner device such that the operations described herein with reference to the networked devices 200 and the operations described herein with reference to the centralized computing device 300 may be performed by each device 200, 300 in the datacenter cluster 100. In such an example embodiment, each networked device 200 may locally determine (e.g., compute or the like) gradients based on the data observed by the respective networked device 200. Each networked device 200 may subsequently share its gradients with the fellow networked devices 200 within the datacenter cluster 100. As described hereafter, the gradients may be determined locally by the networked devices 200 via example gradient descent operations. In such an implementation, the data packets that are described as transmitted from the networked devices 200 (e.g., the worker devices) to a centralized computing device 300 (e.g., the learner device) may instead refer to the data transmissions between and amongst the networked devices 200 forming the datacenter cluster 200 (e.g., the data packets may be the transmission of the gradients). By any of the networked devices 200 operating as a worker device and a learner device, the centralized computing device 300 (e.g., any of the networked devices 200) may also be selected via a MPI communication protocol and operate to, for example, distributing gradients amongst the other networked devices 200.

### Example DPU Configuration

As described above, in some embodiments, one or more of the networked device(s) 200 and/or the centralized computing device 300 may include a DPU 600. With reference to FIG. 6, an example DPU 600 is illustrated that may, for example, operate, in whole or in part, as any of the networked devices 200 and/or the centralized computing device 300. Although described hereinafter with reference to an example DPU 600 performing at least a portion of the operations of FIGS. 7-8, the present disclosure contemplates that the operations described herein may be performed by any computing device (e.g., CPU, GPU, etc.) without limitation.

As shown in FIG. 6, the networked device(s) 200 and/or the centralized computing device 300 may include one or more application-specific integrated circuits (ASICs) 612a-n that are communicably coupled with a data processing unit (DPU) 600. The one or more ASICs 612a-n may be configured for performing one or more networking operations and may be specific to the particular functionality associated with the networked device(s) 200 and/or the centralized computing device 300. By way of non-limiting example, the one or more ASICs 612a-612n may be configured to operate as network ports in which traffic (e.g., data, signals, etc.) are directed to various components, devices, etc. communicably coupled with the ASICs 612a-n. The present disclosure contemplates that the networked device(s) 200 and/or the centralized computing device 300 may include any number of ASICs 612a-n (e.g., a plurality of ASICs 612a-n) based upon the intended application of the device(s) 200, 300. Additionally, the present disclosure contemplates that the operations performed by the one or more ASICs 612a-n may similarly vary based upon the intended application of the device(s) 200, 300. Still further, the present disclosure contemplates that the number, configuration, orientation, operations, etc. of the ASICs 612a-n may vary between device(s) 200, 300. As shown, the DPU 600 may include a high-performance, software-programmable CPU 608 that is communicably coupled with a network interface controller (NIC) 610.

### Example Methods for Datacenter Cluster Level Machine Learning

FIG. 7 illustrates a flowchart containing a series of operations for generating, locally within a datacenter cluster, updated operational parameters for machine learning based tasks (e.g., method 700). The operations illustrated in FIG. 7 may, for example, be performed by, with the assistance of, and/or under the control of an apparatus (e.g., centralized computing device 300), as described above. In this regard, performance of the operations may invoke one or more of processor 302, memory 306, and/or communication interface 304.

As shown in operation 702, the apparatus (e.g., centralized computing device 300) includes means, such as processor 202, or the like, for receiving one or more data packets from at least one networked device 200 communicably coupled with the centralized computing device 300. As described above, the networked devices 200 of the present disclosure may be associated with the performance of various machine learning based tasks. By way of a nonlimiting example, the devices 200, 300 of the datacenter cluster 100 may be associated with any number of algorithmic operations (e.g., congestion control, cluster wide zero thermal throttling (ZTT), node synchronization, error correction, power management, motherboard configuration, adaptive routing, NIC configuration tuning, etc.). In some embodiments, the machine learning based task may refer to operations that are directly performed by the networked devices 200, such as in embodiments in which at least a portion of the operations performed by the networked device(s) 200 may be considered machine learning based.

In other embodiments, the association with machine learning based tasks may refer to operations that are performed by the networked devices 200 that are impacted, influenced, controlled, or otherwise affected by the performance of an associated machine learning algorithm, technique, or the like (e.g., a ML algorithm performed by the centralized computing device 300). Example embodiments are described hereinafter with reference to a first machine learning based task or algorithm associated with congestion control. The present disclosure, however, contemplates that the machine learning based tasks or algorithms described herein may refer to any algorithm associated with networking and/or datacenter operation, such as cluster wide zero thermal throttling (ZTT), node synchronization, error correction, power management, motherboard configuration, adaptive routing, NIC configuration tuning, and/or the like. Although described with reference to an example first networked device 200a, the present disclosure contemplates that the operations of FIG. 7 may be associated with any number of networked devices 200a-n. In some embodiments, the updated operational parameters generated by the centralized computing device 300 may be based on data entries generated by a plurality of networked devices 200a-n.

With continued reference to operation 702, each of the one or more data packets received by the centralized computing device 300 may include one or more data entries generated by the at least one networked device 200 based on data traffic associated with the at least one networked device 200. As described above, the first networked device 200a may operate as a worker device in that the first networked device 200a may generate data entries that are associated with the operations of the first networked device 200a. For example, the first networked device 200a may generate data entries associated with the data traffic experienced by the first networked device 200a. For example, the first networked device 200a may monitor the data that is transmitted within the datacenter cluster 100 via the first networked device and generate data entries indicative of or otherwise associated with this data traffic. The one or more data entries generated by the first networked device 200a may further be indicative of any decisions or inferences determined by the first network device 200a in the performance of the machine learning based task. By way of example, the first network device 200a may be configured to direct data between devices within the datacenter clusters (e.g., via one or more switches or the like) and may infer the appropriate destination for data based on various operational parameters in accordance with which the first network device operates. The one or more data entries generated by the first network device 200a may further include the outcomes, modifications, etc. of the first network device 200a in response to these inferences, determinations, etc.

As such, the data entries that are generated by the first networked device 200a as part of performance of the at least first machine learning based task may refer to any determinable, monitorable, or otherwise ascertainable parameters, characteristics, attributes, features, etc. associated with the first networked device 200a. By way of a non-limiting example, the data entries generated by the first networked device 200a may be associated with or indicative of the round trip time (RTT) for the first networked device 200a, the bandwidth utilization for the first networked device 200a (e.g., associated with statistics or other counters), telemetry data of any type or kind for the first networked device 200a, physical or environmental characteristics (e.g., temperature, pressure, etc.) for the first networked device 200a, and/or the like. In an instance in which the first machine learning based task refers to an example congestion control algorithm, the one or more data entries included in the data packets received by the centralized computing device 300 may be associated with a latency, packet loss, and/or other telemetry of the first networked device 200a. Furthermore, the data packets received by the centralized computing device 300 may include any modifications to the data entries by the first networked device 200a (e.g., modifications performed locally by the respective networked device 200a-n). The data packets described herein may refer to the data structure by which the data entries generated by the first networked device 200a are provided to the centralized computing device 300 as described above. As such, the first data packets may include any structure, configuration, etc. required by the datacenter cluster 100 in order for these data entries to be provided to the centralized computing device 300.

Thereafter, as shown in operation 704, the apparatus (e.g., centralized computing device 300) includes means, such as processor 202, or the like, for generating one or more updated operational parameters associated with the first machine learning based task based on the one or more data entries forming the plurality of data packets. As described herein, the generation of these updated operational parameters occurs locally by the centralized computing device 300 (e.g., without the need for offline operations or access to computing resources of other network levels). As described further hereinafter with reference to the operations of FIG. 8, the centralized computing device 300 may operate to leverage various machine learning models, techniques, etc. to optimize the operational parameters, characteristics, attributes, etc. for particular networked devices based on the unique conditions associated with the particular networked device 200. By way of a nonlimiting example, in some embodiments, the first machine learning model may be associated with a neural network configured to determine the operational parameters (and updates to the same) for each of the network devices 200 forming the datacenter cluster 100.

As would be evident to one of ordinary skill in the art in light of the present disclosure, a neural network may refer to a mathematical model used to approximate nonlinear functions in which neurons or nodes are arranged in various layers of the network. The behavior, operation, etc. of the neural network may, in some instances, vary based on weights of the connections between neurons. In such an embodiment, the centralized computing device 300 may review the data packets that are received from the networked devices 200 and modify the weights of the neural network based on the data packets. In particular, the centralized computing device 300 may perform an optimization process by which the weights of the neural network are improved to account for the data traffic of the networked devices 200 performing machine learning based tasks. These updated operational parameters (e.g., new neural network weights) may be networked device 200 and/or datacenter cluster 100 specific in that the weights of the neural network are uniquely based on the particular operating conditions of the networked devices 200 forming the datacenter cluster 100.

With reference to an example congestion control implementation, the centralized computing device 300 may collect the data entries forming the data packets received from the networked devices 200 (e.g., latency, packet loss, telemetry data, etc.). Thereafter, the centralized computing device 300 may construct the loss (e.g., via a reinforcement learning objective or the like) and perform an update to the algorithmic logic, such as via gradient descent. In such an embodiment, the updated operational parameters that are generated by the centralized computing device 300 (e.g., the learner device) may refer to the gradients determined by the example gradient descent operations. Although described herein with reference to example gradient descent operations as related to congestion control, the present disclosure contemplates that the centralized computing device 300 may generate updated operational parameters associated with any machine learning based task of any number, type, etc. and may leverage any machine learning based techniques, algorithms, etc. based on the nature of the task, datacenter cluster 100, etc.

Thereafter, as shown in operation 706, the apparatus (e.g., centralized computing device 300) includes means, such as processor 202, or the like, for transmitting the one or more updated operational parameters to the at least one networked device 200 (e.g., the example first networked device 200a). The present disclosure contemplates that the centralized computing device 300 may leverage any mechanism for transmitting or otherwise dispersing the updated operational parameters to the networked devices 200. In some embodiments, the updated operational parameters may be transmitted to the networked device(s) 200a-n from the centralized computing device 300 via one or more RDMA operations. Thereafter, the networked devices 200 may operate to update their respective internal operations, characteristics, etc. based on the updated operational parameters received from the centralized computing device 300. By leveraging the infrastructure described herein, the embodiments of the present disclosure may accomplish this operational parameter update at the datacenter cluster 100 level (e.g., without offline user input, without impacting other network devices or levels, etc.).

### Example Methods for ML Model Training

FIG. 8 illustrates a flowchart containing a series of operations for training machine learning models locally within a datacenter cluster 100 in accordance with some embodiments of the present disclosure (e.g., method 800). The operations illustrated in FIG. 8 may, for example, be performed by, with the assistance of, and/or under the control of an apparatus (e.g., centralized computing device 300), as described above. In this regard, performance of the operations may invoke one or more of processor 302, memory 306, and/or communication interface 304.

As shown in operation 802, the apparatus (e.g., centralized computing device 300) includes means, such as processor 302, or the like, for accessing at least a first machine learning model implicating performance of the first machine learning based task. As described above, the datacenter cluster 100 may be formed of various devices 200, 300 that are associated with the performance of machine learning based tasks. As such, the centralized computing device 300 may control, access, or otherwise leverage a plurality of machine learning related algorithms, models, neural networks, etc. In some embodiments, the access at operation 802 may refer to the internal access of the centralized computing device 300 to the first machine learning model (e.g., the example machine learning model) that is at least partially stored by the centralized computing device. In other embodiments, the centralized computing device 300 may be communicably coupled with various storage systems, data repositories, and/or the like that store data associated with the machine learning models applicable to the datacenter cluster 100. In such an embodiment, the centralized computing device 300 may query these data repositories to access the example first machine learning model.

As shown in operation 804, the apparatus (e.g., centralized computing device 300) includes means, such as processor 302, or the like, for training the first machine learning model based on the one or more data entries forming the plurality of data packets. As described herein, the centralized computing device 300 may operate to optimize the operation of the networked devices 200 forming the datacenter cluster 100 with operations that occur local to the datacenter cluster 100. In doing so, the centralized computing device may leverage various machine learning models that may be trained by the data entries forming the data packets that are received by the centralized computing device 300.

As would be evident to one of ordinary skill in the art, a trained ML model may refer to a mathematical model generated by machine learning algorithms based on training data, to make predictions or decisions without being explicitly programmed to do so. To train the ML model, the centralized computing device 300 supply the data entries received from the networked device as a training dataset to any of the machine learning models described herein. In an instance in which the example first machine learning model is associated with congestion control, the data entries supplied to the ML model may be associated with latency, packet loss, and/or other telemetry data. The ML model represents what was learned by the selected machine learning algorithm and represents the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. ML algorithms may refer to programs that are configured to self-adjust and perform better as they are exposed to more data. To this extent, ML algorithms are capable of adjusting their own parameters, given feedback on previous performance in making prediction about a dataset.

The ML algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML model may be trained using repeated execution cycles of experimentation (e.g., iteration 810), testing, and tuning to modify the performance of the ML algorithm and refine the results in preparation for deployment of those results for consumption or decision making. The ML model may be tuned by dynamically varying hyperparameters in each iteration 810 (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized. Said differently, the centralized computing device 300 may be configured to iteratively train the first machine learning model based on iterative receipt of data packets from the at least one networked device 200.

In some embodiments, as shown in operation 806, the apparatus (e.g., centralized computing device 300) includes means, such as processor 302, or the like, for training a neural network based on the one or more data entries forming the plurality of data packets and generating one or more neural network weights as the one or more updated operational parameters. As described above, the neural network may refer to a mathematical model used to approximate nonlinear functions in which neurons or nodes are arranged in various layers of the network. The behavior, operation, etc. of the neural network may, in some instances, vary based on weights of the connections between neurons. In such an embodiment, the centralized computing device 300 may review the data packets that are received from the networked devices 200 and modify the weights of the neural network based on the data packets. In particular, the centralized computing device 300 may perform an optimization process by which the weights of the neural network are improved to account for the data traffic of the networked devices 200 performing machine learning based tasks.

As shown in operation 808, the apparatus (e.g., centralized computing device 300) includes means, such as processor 302, or the like, for generating the one or more updated operational parameters based on an outcome of the first machine learning model. These updated operational parameters (e.g., new neural network weights) may be networked device 200 and/or datacenter cluster 100 specific in that the weights of the neural network are uniquely based on the particular operations conditions of the networked devices 200 forming the datacenter cluster 100. With continued reference to an example congestion control implementation, the one or more updated operations parameters may refer to the gradients determined by the example gradient descent operations based on the loss constructed (e.g., via a reinforcement learning objective or the like) and updates to the algorithmic logic, such as via gradient descent operations. Although described herein with reference to example gradient descent operations as related to congestion control, the present disclosure contemplates that the centralized computing device 300 may generate updated operational parameters associated with any machine learning based task of any number, type, etc. and may leverage any machine learning based techniques, algorithms, etc. based on the nature of the task, datacenter cluster 100, etc.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A computer-implemented method for machine learning, the method comprising:
receiving, by a centralized computing device, one or more data packets from at least one networked device communicably coupled with the centralized computing device, wherein:
the at least one networked device is associated with performance of at least a first machine learning based task, and
each of the one or more data packets comprise one or more data entries generated by the at least one networked device based on data traffic associated with the at least one networked device and/or one or more modifications thereto by the at least one networked device;
generating one or more updated operational parameters associated with the first machine learning based task based on the one or more data entries forming the plurality of data packets, wherein the one or more updated operational parameters are generated locally by the centralized computing device; and
transmitting, by the centralized computing device, the one or more updated operational parameters to the at least one networked device.

2. The computer-implemented method according to claim 1, further comprising:
accessing at least a first machine learning model implicating performance of the first machine learning based task;
training the first machine learning model based on the one or more data entries forming the plurality of data packets; and
generating the one or more updated operational parameters based on an outcome of the first machine learning model.

3. The computer-implemented method according to claim 2, further comprising iteratively training the first machine learning model based on iterative receipt of data packets from the at least one networked device.

4. The computer-implemented method according to claim 2, wherein the first machine learning model is associated with a neural network, the method further comprising:
training the neural network based on the one or more data entries forming the plurality of data packets; and
generating one or more neural network weights as the one or more updated operational parameters.

5. The computer-implemented method according to claim 1, wherein the centralized computing device comprises a data processing unit (DPU).

6. The computer-implemented method according to claim 1, wherein the centralized computing device further comprises a graphics processing unit (GPU) configured to generate the one or more updated operational parameters associated with the first machine learning based task.

7. The computer-implemented method according to claim 1, wherein the centralized computing device is communicably coupled with a plurality of networked devices including the at least one networked device, wherein each of the plurality of networked devices are associated with performance of at least the first machine learning based task.

8. A computer program product for machine learning comprising at least one non-transitory computer-readable storage medium having computer program code thereon that, in execution with at least one processor, configures the computer program product for:
receiving, by a centralized computing device, one or more data packets from at least one networked device communicably coupled with the centralized computing device, wherein:
the at least one networked device is associated with performance of at least a first machine learning based task, and
each of the one or more data packets comprise one or more data entries generated by the at least one networked device based on data traffic associated with the at least one networked device;
generating one or more updated operational parameters associated with the first machine learning based task based on the one or more data entries forming the plurality of data packets, wherein the one or more updated operational parameters are generated locally by the centralized computing device; and
transmitting, by the centralized computing device, the one or more updated operational parameters to the at least one networked device.

9. The computer program product according to claim 8, further configured for:
accessing at least a first machine learning model implicating performance of the first machine learning based task;
training the first machine learning model based on the one or more data entries forming the plurality of data packets; and
generating the one or more updated operational parameters based on an outcome of the first machine learning model.

10. The computer program product according to claim 9, further configured for iteratively training the first machine learning model based on iterative receipt of data packets from the at least one networked device.

11. The computer program product according to claim 9, wherein the first machine learning model is associated with a neural network, the computer program product further configured for:
training the neural network based on the one or more data entries forming the plurality of data packets; and
generating one or more neural network weights as the one or more updated operational parameters.

12. The computer program product according to claim 8, wherein the centralized computing device comprises a data processing unit (DPU).

13. The computer program product according to claim 8, wherein the centralized computing device is communicably coupled with a plurality of networked devices including the at least one networked device, wherein each of the plurality of networked devices are associated with performance of at least the first machine learning based task.

14. A centralized computing device comprising:
a non-transitory storage device; and
a processor coupled to the non-transitory storage device, wherein the processor is configured to:
receive one or more data packets from at least one networked device, wherein:
the at least one networked device is associated with performance of at least a first machine learning based task, and
each of the one or more data packets comprise one or more data entries generated by the at least one networked device based on data traffic associated with the at least one networked device and/or one or modifications by the at least one networked device; and
generate one or more updated operational parameters associated with the first machine learning based task based on the one or more data entries forming the plurality of data packets, wherein the one or more updated operational parameters are generated locally by the centralized computing device; and
transmit the one or more updated operational parameters to the at least one networked device.

15. The centralized computing device according to claim 14, wherein the processor is further configured to:
access at least a first machine learning model implicating performance of the first machine learning based task;
train the first machine learning model based on the one or more data entries forming the plurality of data packets; and
generate the one or more updated operational parameters based on an outcome of the first machine learning model.

16. The centralized computing device according to claim 15, wherein the processor is further configured to iteratively training the first machine learning model based on iterative receipt of data packets from the at least one networked device.

17. The centralized computing device according to claim 15, wherein the first machine learning model is associated with a neural network, the processor further configured to:
train the neural network based on the one or more data entries forming the plurality of data packets; and
generate one or more neural network weights as the one or more updated operational parameters.

18. The centralized computing device according to claim 14, wherein the centralized computing device comprises a data processing unit (DPU).

19. The centralized computing device according to claim 14, wherein the centralized computing device further comprises a graphics processing unit (GPU) configured to generate the one or more updated operational parameters associated with the first machine learning based task.

20. The centralized computing device according to claim 14, wherein the centralized computing device is communicably coupled with a plurality of networked devices including the at least one networked device, wherein each of the plurality of networked devices are associated with performance of at least the first machine learning based task.
